(19) United States
(12) Patent Application Publication
(10) Pub. No.: US 2011/0056215 A1
(43) Pub. Date: Mar. 10, 2011

(54) WIRELESS POWER FOR HEATING OR COOLING

(75) Inventors: Sang Won Ham, Downey, CA (US); Julie Xiaoshu Kuang, San Diego, CA (US); David Joseph Vanoni, Carlsbad, CA (US)

(73) Assignee: QUALCOMM INCORPORATED, San Diego, CA (US)

(21) Appl. No.: 12/849,710

(22) Filed: Aug. 3, 2010

Related U.S. Application Data
(60) Provisional application No. 61/241,337, filed on Sep. 10, 2009.

(51) Int. Cl. F25B 21/02; G05D 23/00

(52) U.S. Cl. 62/3.7; 236/51

(57) ABSTRACT

Exemplary embodiments are directed to heating or cooling with wireless power. A device may comprise a wireless power receiver having at least one associated receive antenna. The device may further include a thermoelectric element operably coupled to the wireless power receiver and configured to heat or cool at least a portion of the device upon receipt of wireless power.

### CLAIM OF PRIORITY UNDER 35 U.S.C. §119

This application claims priority under 35 U.S.C. §119(e) to U.S. Provisional Patent Application No. 61/241,337 entitled “WIRELESSLY POWERED HEATING OR COOLING” filed on Sep. 10, 2009, the disclosure of which is hereby incorporated by reference in its entirety.

### BACKGROUND

1. Field

The present invention relates generally to wireless power, and more specifically to thermoelectric cooling or heating via wireless power.

2. Background

Typically, each battery powered device requires its own charger and power source, which is usually an AC power outlet. This becomes unwieldy when many devices need charging.

Approaches are being developed that use over-the-air power transmission between a transmitter and the device to be charged. These generally fall into two categories. One is based on the coupling of plane wave radiation (also called far-field radiation) between a transmit antenna and receive antenna on the device to be charged which collects the radiated power and rectifies it for charging the battery. Antennas are generally of resonant length in order to improve the coupling efficiency. This approach suffers from the fact that the power coupling falls off quickly with distance between the antennas. So charging over reasonable distances (e.g., >1-2m) becomes difficult. Additionally, since the system radiates plane waves, unintentional radiation can interfere with other systems if not properly controlled through filtering.

Other approaches are based on inductive coupling between a transmit antenna embedded, for example, in a “charging” mat or surface and a receive antenna plus rectifying circuit embedded in the host device to be charged. This approach has the disadvantage that the spacing between transmit and receive antennas must be very close (e.g. mms). Though this approach does have the capability to simultaneously charge multiple devices in the same area, this area is typically small, hence the user must locate the devices to a specific area.

Wireless power transfer may find other applications in addition to charging a power storage device. Accordingly, there are other needs for systems, methods and devices that utilize transmitted wireless power to accomplish other desirable outcomes.

### BRIEF DESCRIPTION OF THE DRAWINGS

FIG. 1 shows a simplified block diagram of a wireless power transfer system.

FIG. 2 shows a simplified schematic diagram of a wireless power transfer system.

FIG. 3 illustrates a schematic diagram of a loop antenna for use in exemplary embodiments of the present invention.

FIG. 4 is a simplified block diagram of a transmitter, in accordance with an exemplary embodiment of the present invention.

FIG. 5 is a simplified block diagram of a receiver, in accordance with an exemplary embodiment of the present invention.

FIG. 6 shows a simplified schematic of a portion of transmit circuitry for carrying out messaging between a transmitter and a receiver.

FIG. 7 depicts a wireless power system, in accordance with an exemplary embodiment of the present invention.

FIG. 8 is a block diagram of a wireless power system including a wireless power device and a plurality of devices positioned thereon.

FIG. 9 is a block diagram of another wireless power system including a wireless power device and a plurality of devices positioned thereon.

FIG. 10 illustrates a device positioned on a surface of a display device, according to an exemplary embodiment of the present invention.

FIG. 11 illustrates another positioned on a surface of a display device, in accordance with an exemplary embodiment of the present invention.

FIG. 12 is a flowchart illustrating a method, in accordance with an exemplary embodiment of the present invention.

FIG. 13 is a flowchart illustrating another method, in accordance with an exemplary embodiment of the present invention.

### DETAILED DESCRIPTION

The detailed description set forth below in connection with the appended drawings is intended as a description of exemplary embodiments of the present invention and is not intended to represent the only embodiments in which the present invention can be practiced. The term “exemplary” used throughout this description means “serving as an example, instance, or illustration,” and should not necessarily be construed as preferred or advantageous over other exemplary embodiments. The detailed description includes specific details for the purpose of providing a thorough understanding of the exemplary embodiments of the invention. It will be apparent to those skilled in the art that the exemplary embodiments of the invention may be practiced without these specific details. In some instances, well-known structures and devices are shown in block diagram form in order to avoid obscuring the novelty of the exemplary embodiments presented herein.

The words “wireless power” is used herein to mean any form of energy associated with electric fields, magnetic fields, electromagnetic fields, or otherwise that is transmitted between from a transmitter to a receiver without the use of physical electromagnetic conductors.

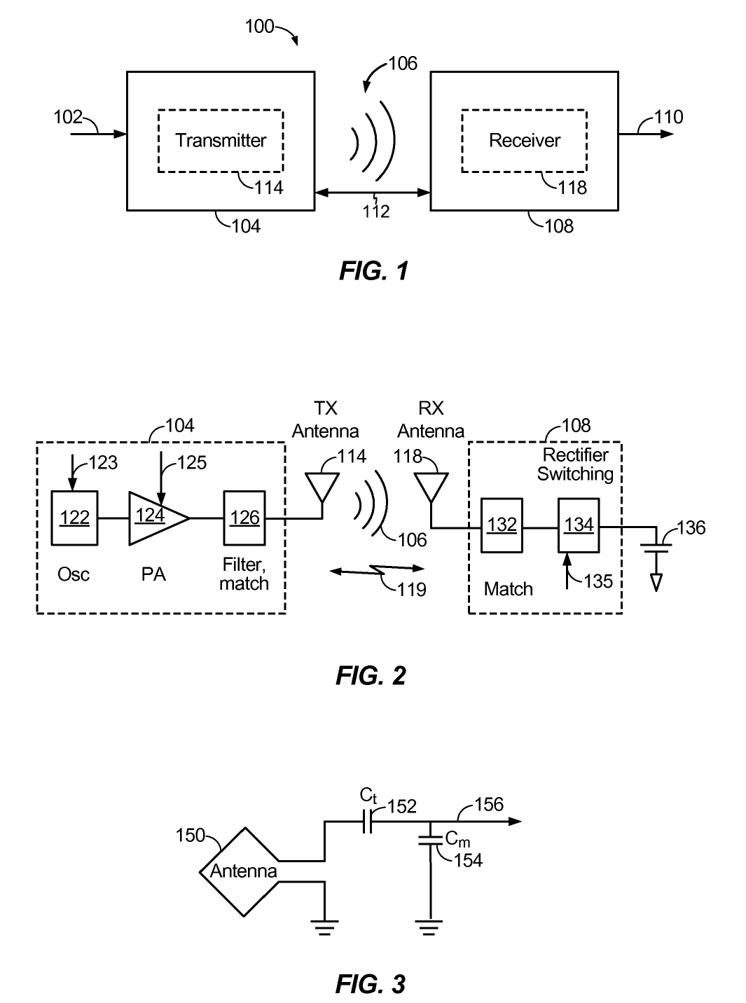

FIG. 1 illustrates a wireless transmission or charging system 100, in accordance with various exemplary embodiments of the present invention. Input power 102 is provided to a transmitter 104 for generating a radiated field 106 for providing energy transfer. A receiver 108 couples to the radiated field 106 and generates an output power 110 for storing or consumption by a device (not shown) coupled to the output power 110. Both the transmitter 104 and the receiver 108 are separated by a distance 112. In one exemplary embodiment, transmitter 104 and receiver 108 are configured according to a mutual resonant relationship and when the resonant frequency of receiver 108 and the resonant frequency of transmitter 104 are very close, transmission losses between the transmitter 104 and the receiver 108 are minimal when the receiver 108 is located in the “near-field” of the radiated field 106.

Transmitter 104 further includes a transmit antenna 114 for providing a means for energy transmission and receiver 108 further includes a receive antenna 118 for providing a means for energy reception. The transmit and receive antennas are sized according to applications and devices to be associated therewith. As stated, an efficient energy transfer occurs by coupling a large portion of the energy in the near-field of the transmitting antenna to a receiving antenna rather than propagating most of the energy in an electromagnetic wave to the far field. When in this near-field a coupling mode may be developed between the transmit antenna 114 and the receive antenna 118. The area around the antennas 114 and 118 where this near-field coupling may occur is referred to herein as a coupling-mode region.

FIG. 2 shows a simplified schematic diagram of a wireless power transfer system. The transmitter 104 includes an oscillator 122, a power amplifier 124 and a filter and matching circuit 126. The oscillator is configured to generate a signal at a desired frequency, which may be adjusted in response to adjustment signal 123. The oscillator signal may be amplified by the power amplifier 124 with an amplification amount responsive to control signal 125. The filter and matching circuit 126 may be included to filter out harmonics or other unwanted frequencies and match the impedance of the transmitter 104 to the transmit antenna 114.

The receiver 108 may include a matching circuit 132 and a rectifier and switching circuit 134 to generate a DC power output to charge a battery 136 as shown in FIG. 2 or power a device coupled to the receiver (not shown). The matching circuit 132 may be included to match the impedance of the receiver 108 to the receive antenna 118. The receiver 108 and transmitter 104 may communicate on a separate communication channel 119 (e.g., Bluetooth, zigbee, cellular, etc).

As illustrated in FIG. 3, antennas used in exemplary embodiments may be configured as a “loop” antenna 150, which may also be referred to herein as a “magnetic” antenna. Loop antennas may be configured to include an air core or a physical core such as a ferrite core. Air core loop antennas may be more tolerable to extraneous physical devices placed in the vicinity of the core. Furthermore, an air core loop antenna allows the placement of other components within the core area. In addition, an air core loop may more readily enable placement of the receive antenna 118 (FIG. 2) within a plane of the transmit antenna 114 (FIG. 2) where the coupled-mode region of the transmit antenna 114 (FIG. 2) may be more powerful.

As stated, efficient transfer of energy between the transmitter 104 and receiver 108 occurs during matched or nearly matched resonance between the transmitter 104 and the receiver 108. However, even when resonance between the transmitter 104 and receiver 108 are not matched, energy may be transferred at a lower efficiency. Transfer of energy occurs by coupling energy from the near-field of the transmitting antenna to the receiving antenna residing in the neighborhood where this near-field is established rather than propagating the energy from the transmitting antenna into free space.

The resonant frequency of the loop or magnetic antennas is based on the inductance and capacitance. Inductance in a loop antenna is generally simply the inductance created by the loop, whereas, capacitance is generally added to the loop antenna's inductance to create a resonant structure at a desired resonant frequency. As a non-limiting example, capacitor 152 and capacitor 154 may be added to the antenna to create a resonant circuit that generates resonant signal 156. Accordingly, for larger diameter loop antennas, the size of capacitance needed to induce resonance decreases as the diameter or inductance of the loop increases. Furthermore, as the diameter of the loop or magnetic antenna increases, the efficient energy transfer area of the near-field increases. Of course, other resonant circuits are possible. As another non-limiting example, a capacitor may be placed in parallel between the two terminals of the loop antenna. In addition, those of ordinary skill in the art will recognize that for transmit antennas the resonant signal 156 may be an input to the loop antenna 150.

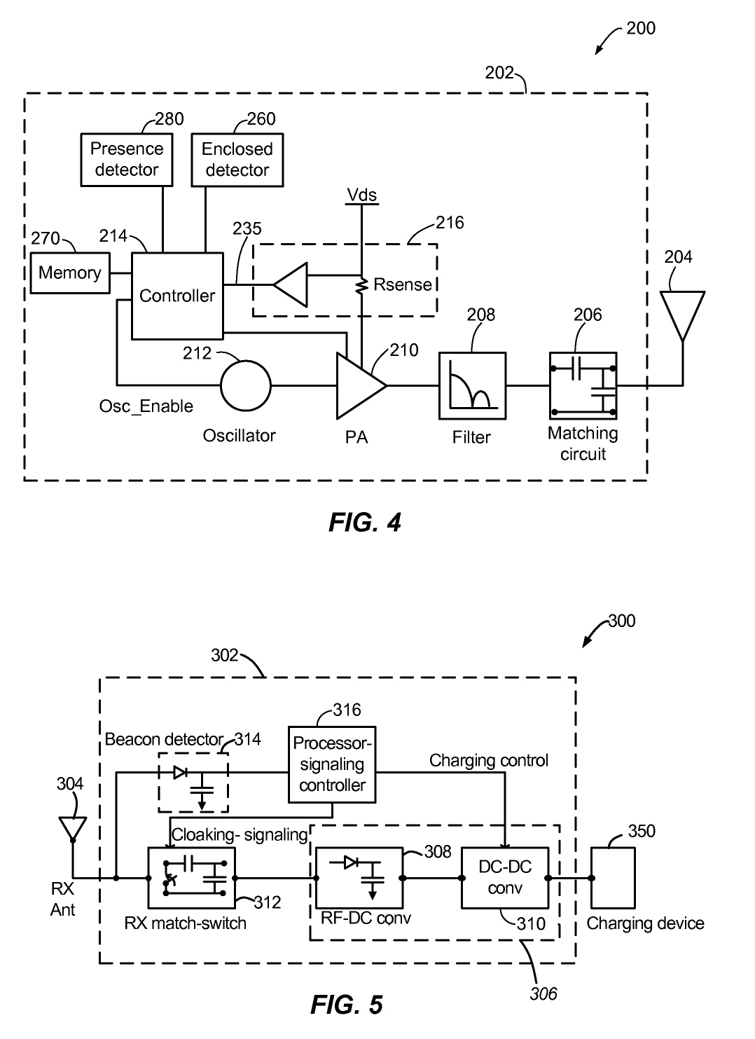

FIG. 4 is a simplified block diagram of a transmitter 200, in accordance with an exemplary embodiment of the present invention. The transmitter 200 includes transmit circuitry 202 and a transmit antenna 204. Generally, transmit circuitry 202 provides RF power to the transmit antenna 204 by providing an oscillating signal resulting in generation of near-field energy about the transmit antenna 204. By way of example, transmitter 200 may operate at the 13.56 MHz ISM band.

Exemplary transmit circuitry 202 includes a fixed impedance matching circuit 206 for matching the impedance of the transmit circuitry 202 (e.g., 50 ohms) to the transmit antenna 204 and a low pass filter (LPF) 208 configured to reduce harmonic emissions to levels to prevent self-jamming of devices coupled to receivers 108 (FIG. 1). Other exemplary embodiments may include different filter topologies, including but not limited to, notch filters that attenuate specific frequencies while passing others and may include an adaptive impedance match, that can be varied based on measurable transmit metrics, such as output power to the antenna or DC current draw by the power amplifier. Transmit circuitry 202 further includes a power amplifier 210 configured to drive an RF signal as determined by an oscillator 212. The transmit circuitry may be comprised of discrete devices or circuits, or alternately, may be comprised of an integrated assembly. An exemplary RF power output from transmit antenna 204 may be on the order of 2.5 Watts.

Transmit circuitry 202 further includes a controller 214 for enabling the oscillator 212 during transmit phases (or duty cycles) for specific receivers, for adjusting the frequency of the oscillator, and for adjusting the output power level for implementing a communication protocol for interacting with neighboring devices through their attached receivers.

The transmit circuitry 202 may further include a load sensing circuit 216 for detecting the presence or absence of active receivers in the vicinity of the near-field generated by transmit antenna 204. By way of example, a load sensing circuit 216 monitors the current flowing to the power amplifier 210, which is affected by the presence or absence of active receivers in the vicinity of the near-field generated by transmit antenna 204. Detection of changes to the loading on the power amplifier 210 are monitored by controller 214 for use in determining whether to enable the oscillator 212 for transmitting energy to communicate with an active receiver.

Transmit antenna 204 may be implemented as an antenna strip with the thickness, width and metal type selected to keep resistive losses low. In a conventional implementation, the transmit antenna 204 can generally be configured for association with a larger structure such as a table, mat, lamp or other less portable configuration. Accordingly, the transmit antenna 204 generally will not need “turns” in order to be of a practical dimension. An exemplary implementation of a transmit antenna 204 may be “electrically small” (i.e., fraction of the wavelength) and tuned to resonate at lower usable frequencies by using capacitors to define the resonant frequency. In an exemplary application where the transmit antenna 204 may be larger in diameter, or length of side if a square loop, (e.g., 0.50 meters) relative to the receive antenna, the transmit antenna 204 will not necessarily need a large number of turns to obtain a reasonable capacitance.

The transmitter 200 may gather and track information about the whereabouts and status of receiver devices that may be associated with the transmitter 200. Thus, the transmitter circuitry 202 may include a presence detector 280, an enclosed detector 290, or a combination thereof, connected to the controller 214 (also referred to as a processor herein). The controller 214 may adjust an amount of power delivered by the amplifier 210 in response to presence signals from the presence detector 280 and the enclosed detector 290. The transmitter may receive power through a number of power sources, such as, for example, an AC-DC converter (not shown) to convert conventional AC power present in a building, a DC-DC converter (not shown) to convert a conventional DC power source to a voltage suitable for the transmitter 200, or directly from a conventional DC power source (not shown).

As a non-limiting example, the presence detector 280 may be a motion detector utilized to sense the initial presence of a device to be charged that is inserted into the coverage area of the transmitter. After detection, the transmitter may be turned on and the RF power received by the device may be used to toggle a switch on the Rx device in a pre-determined manner, which in turn results in changes to the driving point impedance of the transmitter.

As another non-limiting example, the presence detector 280 may be a detector capable of detecting a human, for example, by infrared detection, motion detection, or other suitable means. In some exemplary embodiments, there may be regulations limiting the amount of power that a transmit antenna may transmit at a specific frequency. In some cases, these regulations are meant to protect humans from electromagnetic radiation. However, there may be environments where transmit antennas are placed in areas not occupied by humans, or occupied infrequently by humans, such as, for example, garages, factory floors, shops, and the like. If these environments are free from humans, it may be permissible to increase the power output of the transmit antennas above the normal power restrictions regulations. In other words, the controller 214 may adjust the power output of the transmit antenna 204 to a regulatory level or lower in response to human presence and adjust the power output of the transmit antenna 204 to a level above the regulatory level when a human is outside a regulatory distance from the electromagnetic field of the transmit antenna 204.

As a non-limiting example, the enclosed detector 290 (may also be referred to herein as an enclosed compartment detector or an enclosed space detector) may be a device such as a sense switch for determining when an enclosure is in a closed or open state. When a transmitter is in an enclosure that is in an enclosed state, a power level of the transmitter may be increased.

In exemplary embodiments, a method by which the transmitter 200 does not remain on indefinitely may be used. In this case, the transmitter 200 may be programmed to shut off after a user-determined amount of time. This feature prevents the transmitter 200, notably the power amplifier 210, from running long after the wireless devices in its perimeter are fully charged. This event may be due to the failure of the circuit to detect the signal sent from either the repeater or the receive coil that a device is fully charged. To prevent the transmitter 200 from automatically shutting down if another device is placed in its perimeter, the transmitter 200 automatic shut off feature may be activated only after a set period of lack of motion detected in its perimeter. The user may be able to determine the inactivity time interval, and change it as desired. As a non-limiting example, the time interval may be longer than that needed to fully charge a specific type of wireless device under the assumption of the device being initially fully discharged.

FIG. 5 is a simplified block diagram of a receiver 300, in accordance with an exemplary embodiment of the present invention. The receiver 300 includes receive circuitry 302 and a receive antenna 304. Receiver 300 further couples to device 350 for providing received power thereto. It should be noted that receiver 300 is illustrated as being external to device 350 but may be integrated into device 350. Generally, energy is propagated wirelessly to receive antenna 304 and then coupled through receive circuitry 302 to device 350.

Receive antenna 304 is tuned to resonate at the same frequency, or near the same frequency, as transmit antenna 204 (FIG. 4). Receive antenna 304 may be similarly dimensioned with transmit antenna 204 or may be differently sized based upon the dimensions of the associated device 350. By way of example, device 350 may be a portable electronic device having diametric or length dimension smaller that the diameter of length of transmit antenna 204. In such an example, receive antenna 304 may be implemented as a multi-turn antenna in order to reduce the capacitance value of a tuning capacitor (not shown) and increase the receive antenna's impedance. By way of example, receive antenna 304 may be placed around the substantial circumference of device 350 in order to maximize the antenna diameter and reduce the number of loop turns (i.e., windings) of the receive antenna and the inter-winding capacitance.

Receive circuitry 302 provides an impedance match to the receive antenna 304. Receive circuitry 302 includes power conversion circuitry 306 for converting a received RF energy source into charging power for use by device 350. Power conversion circuitry 306 includes an RF-to-DC converter 308 and may also in include a DC-to-DC converter 310. RF-to-DC converter 308 rectifies the RF energy signal received at receive antenna 304 into a non-alternating power while DC-to-DC converter 310 converts the rectified RF energy signal into an energy potential (e.g., voltage) that is compatible with device 350. Various RF-to-DC converters are contemplated, including partial and full rectifiers, regulators, bridges, doublers, as well as linear and switching converters.

Receive circuitry 302 may further include switching circuitry 312 for connecting receive antenna 304 to the power conversion circuitry 306 or alternatively for disconnecting the power conversion circuitry 306. Disconnecting receive antenna 304 from power conversion circuitry 306 not only suspends charging of device 350, but also changes the “load” as “seen” by the transmitter 200 (FIG. 2).

As disclosed above, transmitter 200 includes load sensing circuit 216 which detects fluctuations in the bias current provided to transmitter power amplifier 210. Accordingly, transmitter 200 has a mechanism for determining when receivers are present in the transmitter's near-field.

When multiple receivers 300 are present in a transmitter's near-field, it may be desirable to time-multiplex the loading and unloading of one or more receivers to enable other receivers to more efficiently couple to the transmitter. A receiver may also be cloaked in order to eliminate coupling to other nearby receivers or to reduce loading on nearby transmitters. This “unloading” of a receiver is also known herein as a “cloaking” Furthermore, this switching between unloading and loading controlled by receiver 300 and detected by transmitter 200 provides a communication mechanism from receiver 300 to transmitter 200 as is explained more fully below. Additionally, a protocol can be associated with the switching which enables the sending of a message from receiver 300 to transmitter 200. By way of example, a switching speed may be on the order of 100 μsec.

In an exemplary embodiment, communication between the transmitter and the receiver refers to a device sensing and charging control mechanism, rather than conventional two-way communication. In other words, the transmitter uses on/off keying of the transmitted signal to adjust whether energy is available in the near-filed. The receivers interpret these changes in energy as a message from the transmitter. From the receiver side, the receiver uses tuning and de-tuning of the receive antenna to adjust how much power is being accepted from the near-field. The transmitter can detect this difference in power used from the near-field and interpret these changes as a message from the receiver.

Receive circuitry 302 may further include signaling detector and beacon circuitry 314 used to identify received energy fluctuations, which may correspond to informational signaling from the transmitter to the receiver. Furthermore, signaling and beacon circuitry 314 may also be used to detect the transmission of a reduced RF signal energy (i.e., a beacon signal) and to rectify the reduced RF signal energy into a nominal power for awakening either un-powered or power-depleted circuits within receive circuitry 302 in order to configure receive circuitry 302 for wireless charging.

Receive circuitry 302 further includes processor 316 for coordinating the processes of receiver 300 described herein including the control of switching circuitry 312 described herein. Cloaking of receiver 300 may also occur upon the occurrence of other events including detection of an external wired charging source (e.g., wall/USB power) providing charging power to device 350. Processor 316, in addition to controlling the cloaking of the receiver, may also monitor beacon circuitry 314 to determine a beacon state and extract messages sent from the transmitter. Processor 316 may also adjust DC-to-DC converter 310 for improved performance.

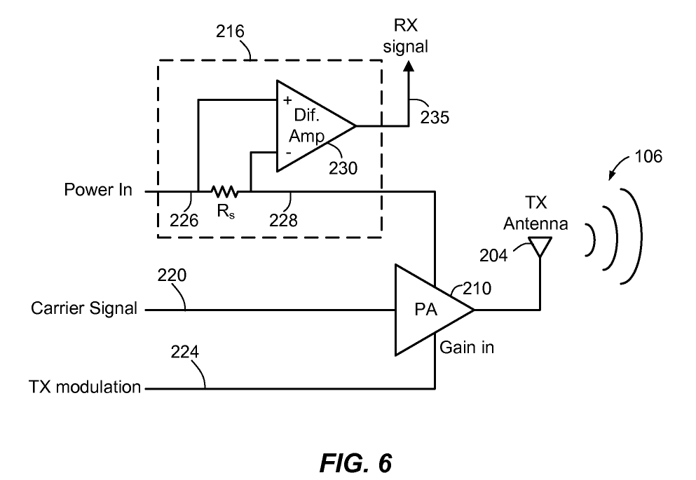

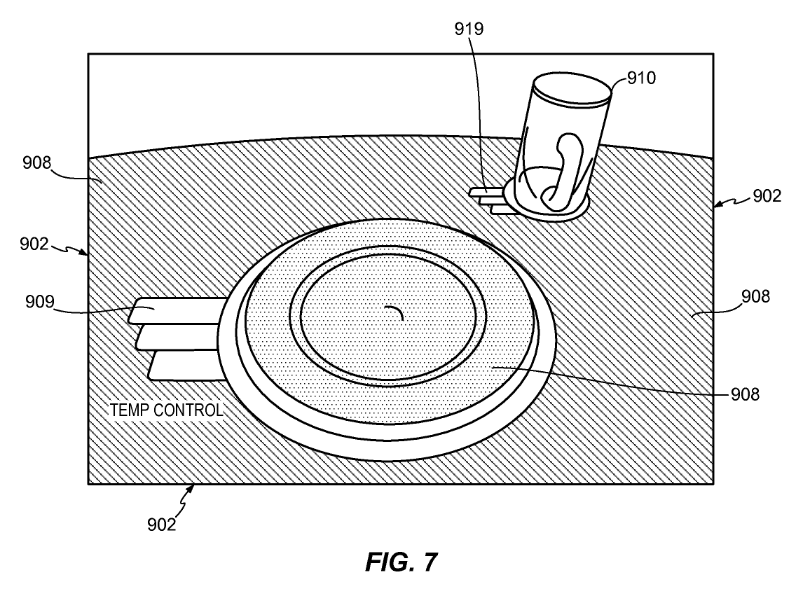

FIG. 6 shows a simplified schematic of a portion of transmit circuitry for carrying out messaging between a transmitter and a receiver. In some exemplary embodiments of the present invention, a means for communication may be enabled between the transmitter and the receiver. In FIG. 6 a power amplifier 210 drives the transmit antenna 204 to generate the radiated field. The power amplifier is driven by a carrier signal 220 that is oscillating at a desired frequency for the transmit antenna 204. A transmit modulation signal 224 is used to control the output of the power amplifier 210.

The transmit circuitry can send signals to receivers by using an ON/OFF keying process on the power amplifier 210. In other words, when the transmit modulation signal 224 is asserted, the power amplifier 210 will drive the frequency of the carrier signal 220 out on the transmit antenna 204. When the transmit modulation signal 224 is negated, the power amplifier will not drive out any frequency on the transmit antenna 204.

The transmit circuitry of FIG. 6 also includes a load sensing circuit 216 that supplies power to the power amplifier 210 and generates a receive signal 235 output. In the load sensing circuit 216 a voltage drop across resistor Rₛ develops between the power in signal 226 and the power supply 228 to the power amplifier 210. Any change in the power consumed by the power amplifier 210 will cause a change in the voltage drop that will be amplified by differential amplifier 230. When the transmit antenna is in coupled mode with a receive antenna in a receiver (not shown in FIG. 6) the amount of current drawn by the power amplifier 210 will change. In other words, if no coupled mode resonance exist for the transmit antenna 204, the power required to drive the radiated field will be a first amount. If a coupled mode resonance exists, the amount of power consumed by the power amplifier 210 will go up because much of the power is being coupled into the receive antenna. Thus, the receive signal 235 can indicate the presence of a receive antenna coupled to the transmit antenna 235 and can also detect signals sent from the receive antenna. Additionally, a change in receiver current draw will be observable in the transmitter's power amplifier current draw, and this change can be used to detect signals from the receive antennas.

As stated, there are other applications for wireless power in addition to charging or powering an electronic device. For example, and as will be understood by a person having ordinary skill in the art, a thermoelectric effect may be exhibited in a circuit in which metal(s) and/or semiconductor(s) having different thermoelectric properties are joined. The generation of an electric current in such a circuit when there is a difference in temperature at the junction is referred to as a Seebeck effect. Thermoelectric conversion modules which exhibit the Seebeck effect have been utilized as, for example, a power generating apparatus. Furthermore, when an electrical current flows through a circuit, the generation of heat on one side and absorption of heat on the other side of the junction occurs. This is referred to as a Peltier effect. More specifically, the Peltier effect is the heating of one junction and the cooling of an associated second junction when an electric current is maintained in junctions having two dissimilar conductors. That is, when the electric current passes through a junction of two dissimilar materials, heat is either absorbed or released depending on the direction of the electric current through the junction. Since an electric current must be closed in order to ensure a continuous current, in any closed circuit, both cooling (cold) and heating (hot) junctions exist. Thus, the presence of the electric current merely moves the heat from one place to another, and as such, a Peltier device may be used as a heat pump in heating and cooling applications. The Peltier device can also be operated in reverse, so that by maintaining a temperature difference between the hot and cold junctions an electric current can be generated.

Various exemplary embodiments as described herein are related to a wireless power system, wireless power receivers, and wireless power transmitters. A wireless power system may include at least one wireless power transmitter and at least one wireless power receiver. According to an exemplary embodiment, at least one wireless power transmit antenna may be positioned proximate a charging surface of a wireless power device, which may include the at least one wireless power transmitter. The at least one wireless power receiver may include at least one receive antenna, which may be positioned within a near-field region of the at least one transmit antenna of the wireless power transmitter. The at least one wireless power receiver, which may be integrated within a device, may further include a thermoelectric element (e.g., a Peltier device) configured to cool or heat at least a portion of the device in response to receipt of wireless power. Accordingly, the wireless power system may be configured to heat or cool a device (e.g., tableware or a tablemat, such as a placemat or a coaster), which is positioned proximate to or which includes the at least one wireless power receiver.

In accordance with one exemplary embodiment, a device to be cooled or heated (e.g., tableware) may be positioned adjacent to (e.g., positioned on) a tablemat (e.g., a coaster or a placemat) that includes the at least one wireless power receiver. Furthermore, the tablemat that includes the at least one wireless power receiver may be positioned on a charging surface of the wireless power device, which includes the at least one wireless power transmitter. As a more specific example, a wireless power device, including at least one wireless power transmitter, may be integrated within a table (e.g., a table within a restaurant) and may be configured to convey wireless power to at least one wireless power receiver having at least one receive antenna. The wireless power receiver, which may be integrated in, for example only, a coaster or a placemat, may be coupled to at least one thermoelectric element (e.g., Peltier device) configured to heat or cool at least a portion of the coaster or the placemat via a thermoelectric method (i.e., Peltier effect). Furthermore, tableware, such as, for example only, a plate, a glass, or a cup, positioned on the coaster or placemat may be heated or cooled via conduction. Additionally, contents on or within the tableware (e.g., food or beverage) may be heated or cooled via conduction.

Moreover, according to another exemplary embodiment of the present invention, tableware (e.g., drinkware or dishware) may include a wireless power receiver having at least one receive antenna and at least one thermoelectric element coupled thereto. As such, in this exemplary embodiment, the tableware, which may be positioned on a wireless power device (e.g., a table) having at least one transmit antenna, may be configured to wirelessly receive power. Furthermore, upon receipt of wireless power, the thermoelectric element may be configured to heat or cool at least a portion of the tableware via a thermoelectric method (i.e., Peltier effect). Additionally, contents on or within the tableware (e.g., food or beverage) may be heated or cooled via conduction.

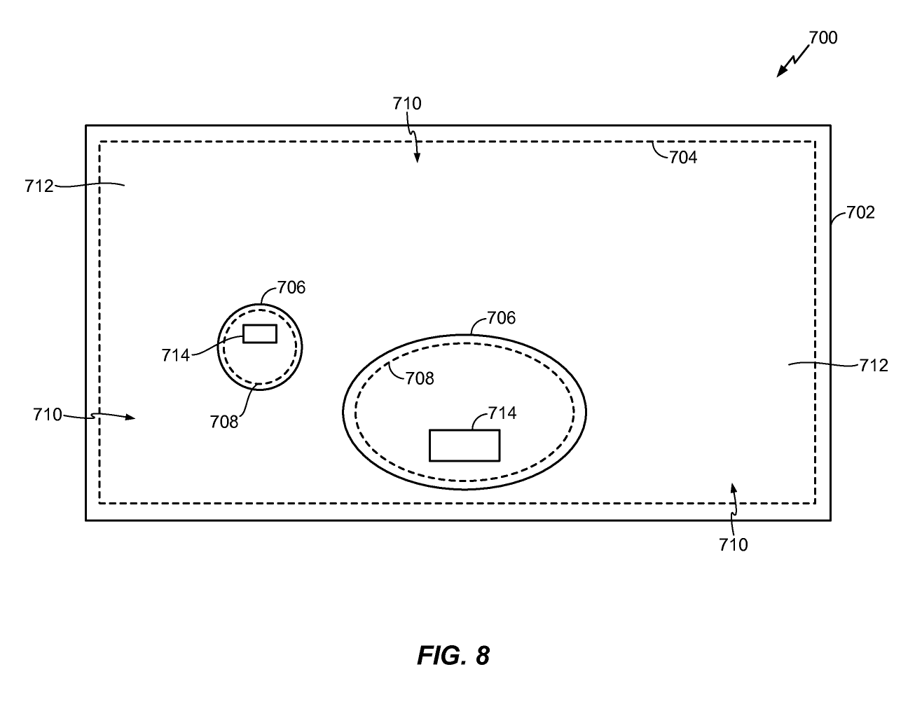

FIG. 7 illustrates a charging surface 908 of a wireless power device 902 having a first device 900 and a second device 910 positioned thereon. It is noted that although first device 900 and second device 910 are each illustrated as a tableware device (i.e., a plate and a glass, respectively), first device 900 and second device 910 may each comprise any known tableware device (e.g., cup, plate, or glass) or tablemat device (e.g., a coaster or a placemat). According to one exemplary embodiment, wireless power device 902 may be configured to convey wireless power, which may be received by a receiver (not shown) within a receiver device (e.g., first device 900 or second device 910). Furthermore, upon receiving wireless power, first device 900 and second device 910 may each be configured to heat or cool at least a portion of itself via one or more thermoelectric methods (i.e., Peltier effect). More specifically, for example, each of first device 900 and a second device 910 may include a thermoelectric element, which may be configured to, upon receipt of wireless power, cool or heat at least a portion of the associated device via one or more thermoelectric methods known in the art.

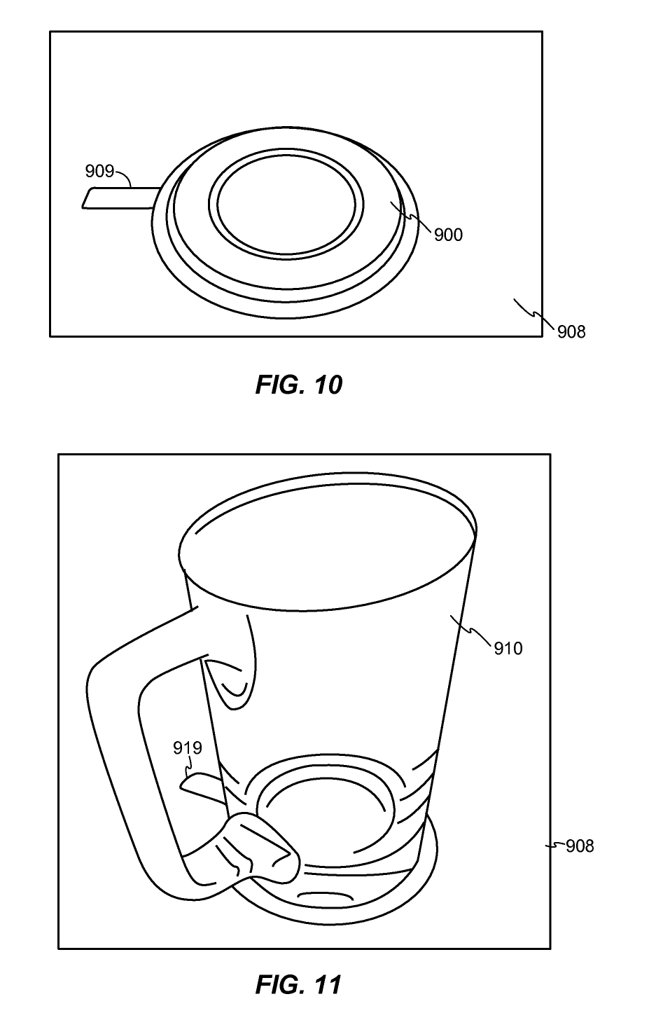

Moreover, charging surface 908, which may comprise a multi-touch display screen, may be configured to display a virtual controller 909/919 for each device (e.g., virtual controller 909 for first device 900 or virtual controller 919 for second device 910) positioned within a near-field region of wireless power device 902 and configured to heat or cool at least a portion of itself via a thermoelectric method. More specifically, virtual controller 909 associated with first device 900 may be configured to enable a device user to control a temperature of first device 900 and virtual controller 919 associated with second device 910 may be configured to enable a device user to control a temperature of second device 910. Yet more specifically, for example, a device user may interact with virtual controller 909 via touch to adjust a temperature of first device 900 associated therewith. Similarly, a device user may interact with virtual controller 919 via touch to adjust a temperature of second device 910 associated therewith. FIG. 10 is another depiction of first device 900 positioned on charging surface 908 with associated virtual controller displayed 909 adjacent thereto. Moreover, FIG. 11 is another illustration of second device 910 positioned on charging surface 908 with associated virtual controller 919 displayed adjacent thereto. Temperature control associated with devices positioned within a near-field region of a wireless power device 902 will be described below in further detail.

In accordance with one exemplary embodiment of the present invention, wireless power device 902 may be configured to detect the presence of a device (e.g., first device 900 or second device 910), which includes a receiver, upon placement of the device within a near-field region of wireless power device 902. More specifically, wireless power device 902 may be configured to detect the presence of a device (e.g., tableware or a tablemat) having a receiver integrated therein upon placement of the device on surface 908. Wireless power device 902 may be configured to detect the presence of a device by any know and suitable means. By way of example only, wireless power device 902 may be configured to detect the presence of a device with one or more sensors (e.g., pressure or light sensors), a presence detector (e.g., presence detector 280 of FIG. 4), or any combination thereof. According to another exemplary embodiment of the present invention, upon being positioned within a near-field region of wireless power device 902, a device (e.g., first device 900 or second device 910) may be configured to notify wireless power device 902 of its presence by any know and suitable means. For example only, a device may notify wireless power device 902 of its presence via communication (e.g., near-field communication (NFC) means).

Additionally, as described more fully below, upon detection or notification of the presence of a device (e.g., first device 900 or second device 910), wireless power device 902 may be configured to display a virtual controller (e.g., virtual controller 909 or virtual controller 919). As noted above, virtual controller 909 may be configured to enable a device user to control a temperature of associated device 900. Yet more specifically, for example, a device user may interact with virtual controller 909 via touch to adjust a temperature of associated device 900.

FIG. 8 is a block diagram of a wireless power system 700, in accordance with an exemplary embodiment of the present invention. Wireless power system 700 includes a wireless power device 702, which may include at least one wireless power transmitter (e.g., transmitter 200 of FIG. 4) including at least one transmit antenna 704. According to one exemplary embodiment, wireless power device 702 may comprise a table (e.g., a dining table). As a more specific example, wireless power device 702 may comprise a table within a restaurant. Moreover, wireless power device 702 may include a display 710, which may comprise, for example only, a touch sensitive screen. Display 710 may be configured to display data (e.g., images, virtual icons, text, video, etc.) on a surface 712 of wireless power device 702. It is noted that the at least one transmit antenna 704 may be positioned approximate surface 712 and may be configured to wirelessly transmit power to one or more chargeable devices positioned within an associated near-field region (e.g., on surface 712).

Wireless power system 700 may further include one or more devices 706, wherein each device 706 includes at least one wireless power receiver (e.g., receiver 300 of FIG. 5) having at least one receive antenna 708. In addition, each device 706 may include a thermoelectric element 714 (e.g., Peltier device) operably coupled to and configured to receive a voltage signal from at least one wireless power receiver associated with device 706. It is noted that devices 706 may comprise, for example, first device 900 or second device 910 described above with regard to FIG. 7.

According to one exemplary embodiment, device 706 may include tableware, which may comprise, for example, dishware (e.g., a plate or a bowl) or drinkware (e.g. a glass or a cup). Accordingly, in this embodiment, upon receiving wireless power at device 706, an associated thermoelectric element 714 may be configured to heat or cool at least a portion of associated device 706. Therefore, contents (i.e., food or drink) within or on device 706 may be heated or cooled. More specifically, if device 706 comprises drinkware, liquid within the drinkware may be cooled or heated. Similarly, if device 706 comprises dishware, food, which is positioned on the dishware, may be heated or cooled.

In accordance with another exemplary embodiment, device 706 may include a tablemat (e.g., coaster or a placemat) configured for positioning tableware thereon. Therefore, in this embodiment, upon receiving wireless power at device 706, an associated thermoelectric element 714 may be configured to heat or cool at least a portion of the associated device 706. Moreover, tableware (e.g., a glass or a plate) positioned on device 706 may be heated or cooled according to the theory of conduction, as will be appreciated by a person having ordinary skill in the art. Furthermore, contents (i.e., food or drink) within or on the tableware may also be heated or cooled via conduction. More specifically, for example, if device 706 comprises a coaster, at least a portion of the coaster, drinkware positioned on the coaster, and liquid within the drinkware may be cooled or heated. Similarly, if device 706 comprises a placemat, at least a portion of the placemat, dishware that is positioned on the placemat, and food that is positioned on the dishware may be heated or cooled.

With reference to FIGS. 7 and 8, temperature control of devices 706 within system 700 will now be described. As noted above, display 710, which may comprise a multi-touch screen, may be configured to display a virtual controller (e.g., virtual controller 909) for each device (e.g., device 706) positioned within a near-field region of wireless power device 702 and configured to heat or cool at least a portion of itself via one or more thermoelectric methods. More specifically, a virtual controller associated with device 706 may be configured to enable a device user to control a temperature of device 706. According to one exemplary embodiment, device 706 may be configured to have a predetermined default temperature associated therewith. For example only, if device 706 comprises either a plate or a placemat, device 706 may be configured to have a default temperature of 150 degrees Fahrenheit. As another example, if device 706 comprises a glass, device 706 may have a default temperature of 35 degrees Fahrenheit. Accordingly, as described more fully below, device 706, wireless power device 702, or a combination thereof, may be configured to adjust an amount of power received by device 706 in order to keep a temperature of device 706 at an associated default temperature. It is noted that device 706 may include one or more temperature sensors and may be configured to communicate a measured temperature to wireless power device 702 via, for example, near-field communication means.

Furthermore, in response to a device user adjusting a temperature of device 706 via a virtual controller (e.g., virtual controller 909), device 706 may be configured to either increase or decrease the temperature associated therewith. More specifically, according to one exemplary embodiment, device 706, which may also comprise a one or more temperature sensors (not shown), may be configured to measure a temperature associated therewith. Furthermore, device 706 may be configured to either increase or decrease the efficiency of wireless power transmission thereto, and, as a result, may increase or decrease the temperature of device 706. More specifically, for example, device 706 may be configured to adjust the tuning of an associated receiver (e.g., receiver 300 of FIG. 5) in order to adjust the amount of wireless power received from wireless power device 702. Accordingly, by decreasing the amount of wireless power received from wireless power device 702, device 706 may decrease a temperature associated therewith. Similarly, by increasing the amount of wireless power received from wireless power device 702, device 706 may increase a temperature associated therewith. It is noted that in this exemplary embodiment, a temperature of each device 706 is independently controllable.

Moreover, in response to a device user adjusting a temperature of device 706 via a virtual controller (e.g., virtual controller 909), wireless power device 702 may be configured to either increase or decrease the temperature associated with one or more devices 706. More specifically, according to another exemplary embodiment, wireless power device 702 may be configured to either increase or decrease the amount of power transmitted to devices 706, and, as a result, may increase or decrease the temperature of devices 706. It is noted that each device 706, which, as noted above, may comprise one or more temperature sensors, may convey a temperature associated therewith to wireless power device 702 via, for example NFC means.

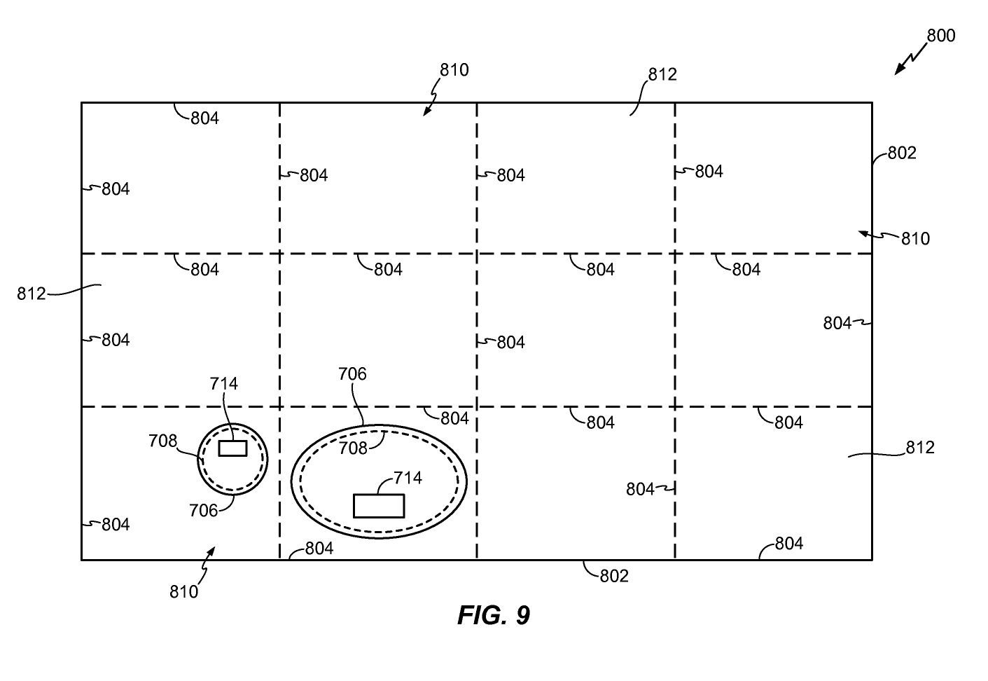

FIG. 9 is a block diagram of a wireless power system 800, in accordance with an exemplary embodiment of the present invention. Wireless power system 800 includes a wireless power device 802, which may include a plurality of transmitters (e.g., transmitter 200 of FIG. 4), wherein each transmitter includes at least one transmit antenna 804. As illustrated, transmit antennas 804 may be configured within wireless power device 802 in a tile pattern. It is noted, however, that although transmit antennas 804 are illustrated as being similar in size; embodiments of the present invention are not so limited. Rather, transmit antennas 804 of various sizes may be positioned within wireless power device 802 in any pattern. Similarly to wireless power device 702, wireless power device 708 may be integrated within a table and may include a display 810, which may comprise, for example only, a touch sensitive screen. Display 810 may be configured to display data (e.g., images, virtual icons, text, video, etc.) on a surface 812 of wireless power device 802. It is noted that each transmit antenna 804 may be positioned approximate surface 812 and may be configured to wirelessly transmit power to one or more chargeable devices positioned within an associated near-field region (e.g., on surface 812).

Wireless power system 800 may further include one or more devices 706, wherein each device 706 includes at least one wireless power receiver (e.g., receiver 300 of FIG. 5) having at least one receive antenna 708. In addition, each device 706 may include thermoelectric element 714 (e.g., Peltier device) operably coupled to and configured to receive a voltage signal from at least one wireless power receiver associated with device 706. As noted above with respect to FIG. 7, device 706 may include tableware, such as dishware (e.g., a plate) or drinkware (e.g. a glass or a cup). Accordingly, in this embodiment, upon receiving wireless power at device 706, an associated thermoelectric element 714 may be configured to heat or cool at least a portion of the associated device. Therefore, contents (i.e., food or drink) within or on device 706 may be heated or cooled via conduction. More specifically, if device 706 comprises drinkware, liquid within the drinkware may be cooled or heated. Similarly, if device 706 comprises dishware, food that is positioned on the dishware may be heated or cooled.

It is noted that, depending on a position on surface 812, device 706 may be located within a near-field of one or more transmit antennas 804, wherein each transmit antenna 804 is independently associated with one or more transmitters (e.g., transmitter 200 of FIG. 4). Stated another way, a first device (e.g., first device 900; see FIG. 7) may be associated with one or more receivers and a second device (e.g., second device 910; see FIG. 7) may be associated with one or more receivers that are independent of the receivers with which the first device are associated.

As described above, device 706 may include a tablemat (e.g., a coaster or a placemat) configured for positioning tableware thereon. Therefore, in this embodiment, upon receiving wireless power at device 706, an associated thermoelectric element 714 may be configured to heat or cool at least a portion of the tablemat. Moreover, tableware positioned on device 706 may be heated or cooled according to the theory of conduction, as will be appreciated by a person having ordinary skill in the art. Furthermore, contents (i.e., food or drink) within or on the tableware may also be heated or cooled via conduction. More specifically, for example, if device 706 comprises a coaster, at least a portion of the coaster, tableware (e.g., a glass) positioned on the coaster, and liquid within the tableware may be cooled or heated. Similarly, if device 706 comprises a placemat, at least a portion of the placemat, dishware that is positioned on the placemat, and food that is positioned on the dishware may be heated or cooled.

With reference to FIGS. 7 and 9, temperature control associated with devices 706 within system 800 will now be described. As noted above, display 810, which may comprise a multi-touch screen, may be configured to display virtual controller (e.g., virtual controller 909) for each device (e.g., device 706) positioned within a near-field region of wireless power device 802 and configured to heat or cool at least a portion of an associated device via one or more thermoelectric methods. More specifically, a virtual controller associated with device 706 may be configured to enable a device user to control a temperature of device 706. As noted above, device 706 may be configured to have a predetermined default temperature associated therewith. For example only, if device 706 comprises either a plate or a placemat, device 706 may be configured to have a default temperature of 150 degrees Fahrenheit. As another example, if device 706 comprises a glass, device 706 may have a default temperature of 35 degrees Fahrenheit. Accordingly, as described more fully below, device 706, wireless power device 802, or a combination thereof, may be configured to adjust an amount of power received by device 706 in order keep device 706 at an associated default temperature. It is noted that device 706 may include one or more temperature sensors and may be configured to communicate a measured temperature to wireless power device 702 via, for example, near-field communication means.

Furthermore, in response to a device user adjusting a temperature of device 706 via a virtual controller (e.g., virtual controller 909), device 706 may be configured to either increase or decrease the temperature associated therewith. More specifically, according to one exemplary embodiment, device 706, which may also comprise a one or more temperature sensors (not shown), may be configured to measure a temperature associated therewith. Furthermore, device 706 may be configured to either increase or decrease the efficiency of wireless power transmission thereto, and, as a result, may increase or decrease the temperature of device 706. Yet more specifically, for example, device 706 may be configured to adjust the tuning of an associated receiver (e.g., receiver 300 of FIG. 5) in order to adjust the amount of wireless power received from wireless power device 702. Accordingly, by decreasing the amount of wireless power received from one or more transmitters of wireless power device 702, device 706 may decrease a temperature associated therewith. Similarly, by increasing the amount of wireless power received from one or more transmitters of wireless power device 702, device 706 may increase a temperature associated therewith.

As stated above, a first device (e.g., first device 900; see FIG. 7) may be associated with one or more receivers and a second device (e.g., second device 910; see FIG. 7) may be associated with one or more receivers that are independent of the receivers with which the first device are associated. Accordingly, the first device may receive power from one or more dedicated transmitters and the second device may receive power from one or more other dedicated transmitters. Moreover, in response to a device user adjusting a temperature of device 706 via a virtual controller (e.g., virtual controller 909), wireless power device 702 may be configured to either increase or decrease the temperature associated with one or more devices 706. More specifically, according to another exemplary embodiment, one or more transmitters associated with device 706 may either increase or decrease the amount of power transmitted to device 706, and, as a result, may increase or decrease the temperature of device 706. It is noted that device 706, which, as noted above, may comprise one or more temperature sensors, may convey a temperature associated therewith to the one or more associated transmitters via, for example, NFC means.

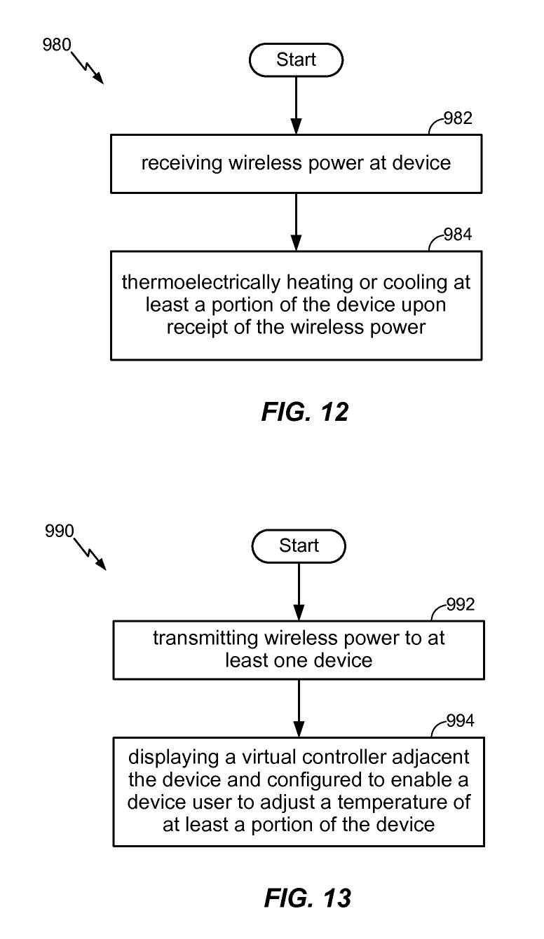

FIG. 12 is a flowchart illustrating a method 980, in accordance with one or more exemplary embodiments. Method 980 may include receiving wireless power at a device (depicted by numeral 982). Method 980 may further include thermoelectrically heating or cooling at least a portion of the device upon receipt of the wireless power (depicted by numeral 984).

FIG. 13 is a flowchart illustrating a method 990, in accordance with one or more exemplary embodiments. Method 990 may include transmitting wireless power to at least one device (depicted by numeral 992). Method 990 may further include displaying a virtual controller adjacent the device and configured to enable a device user to adjust a temperature of at least a portion of the device (depicted by numeral 994).

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the exemplary embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the exemplary embodiments of the invention.

The various illustrative logical blocks, modules, and circuits described in connection with the exemplary embodiments disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the exemplary embodiments disclosed herein may be embodied directly in hardware, in a software module executed by a processor, or in a combination of the two. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the exemplary embodiments shown herein but is to be accorded the widest scope consistent with the principles and novel features disclosed herein.

What is claimed is:

1. A device, comprising:
a wireless power receiver; and
a thermoelectric element operably coupled to the wireless power receiver and configured to heat or cool at least a portion of the device upon receipt of wireless power.

2. The device of claim 1, wherein the device comprises a tablemat.

3. The device of claim 2, wherein the tablemat comprises a coaster, a placemat, or a combination thereof.

4. The device of claim 1, wherein the device comprises tableware.

5. The device of claim 4, wherein the tableware comprises at least one of drinkware and dishware.

6. The device of claim 5, wherein the tableware comprises drinkware and the drinkware comprises at least one of a glass, a cup, and a mug.

7. The device of claim 3, wherein the tableware comprises dishware and the dishware comprises at least one of plate and a bowl.

8. The device of claim 1, wherein the thermoelectric element comprises a Peltier device.

9. A method, comprising:
receiving wireless power at a device; and
thermoelectrically heating or cooling at least a portion of the device upon receipt of the wireless power.

10. The method of claim 9, wherein receiving wireless power at a device comprises receiving wireless power with a receiver integrated within a tableware device.

11. The method of claim 10, further comprising heating or cooling contents positioned on the tableware device or within the tableware device via conduction.

12. The method of claim 11, wherein heating or cooling contents positioned on the tableware device or within the tableware device comprises heating or cooling at least one of food and beverage positioned on the tableware device or within the tableware device.

13. The method of claim 9, wherein receiving wireless power at a device comprises receiving wireless power with a receiver integrated with a tablemat for placing a tableware device.

14. The method of claim 13, wherein receiving wireless power with a receiver integrated within the tablemat comprises receiving wireless power with a receiver integrated within at least one of a coaster and a placemat.

15. The method of claim 13, further comprising heating or cooling one or more tableware devices positioned on the tablemat.

16. The method of claim 9, further comprising adjusting a temperature of the device.

17. The method of claim 16, wherein adjusting a temperature of the device comprises displaying a virtual controller on a display surface of a charging device configured to enable a user to adjust the temperature of the device.

18. The method of claim 16, wherein adjusting a temperature of the device comprises adjusting an efficiency of wireless power transmission between the device and a wireless power transmitter.

19. The method of claim 16, wherein adjusting a temperature of the device comprises adjusting an amount of power transmitted from a wireless power transmitter to the device.

20. The method of claim 16, wherein receiving comprises receiving wireless power from a wireless charging device integrated within a table having at least one transmit antenna position proximate a surface of the table.

21. A device, comprising:
means for receiving wireless power at a device; and
means for thermoelectrically heating or cooling at least a portion of the device upon receipt of the wireless power.

22. An apparatus, comprising:
at least one wireless power transmitter having at least one associated transmit antenna proximate a surface of the apparatus;
a display device proximate the surface and configured to display at least one virtual controller configured to enable control of an amount of wireless power transferred to at least one wireless power receiver positioned within a near-field region of the at least transmit antenna.

23. The apparatus of claim 22, wherein the at least one wireless power transmitter comprises a plurality of wireless power transmitter configured in a tile pattern proximate the surface of the apparatus.

24. The apparatus of claim 22, wherein the at least one wireless power transmitter is configured to adjust an amount of power transmitted to the wireless power receiver in response to adjustment of the associated at least one virtual controller.

25. The apparatus of claim 22, wherein the apparatus comprises a table and the at least one transmit antenna is positioned proximate a surface of the table.

26. The apparatus of claim 22, wherein the at least one virtual controller comprises at least one virtual temperature controller configured to enable temperature control of at least a portion of a device associated with the wireless power receiver.
